(19) United States
(12) Patent Application Publication
(10) Pub. No.: US 2017/0302990 A1
(43) Pub. Date: Oct. 19, 2017

(54) METHOD, TERMINAL, AND SYSTEM FOR PROCESSING DATA OF VIDEO STREAM

(71) Applicant: TENCENT TECHNOLOGY (SHENZHEN) COMPANY LIMITED, Shenzhen (CN)

(72) Inventor: Yulong YING, Shenzhen (CN)

(21) Appl. No.: 15/640,897

(22) Filed: Jul. 3, 2017

Related U.S. Application Data
(63) Continuation of application No. PCT/CN2016/077717, filed on Mar. 29, 2016.

(30) Foreign Application Priority Data
Apr. 15, 2015 (CN) 2015101766281

(51) Int. Cl. H04N 21/438; H04N 21/4425; H04N 21/44; H04L 29/06; H04L 29/08

(52) U.S. Cl. CPC H04N 21/438; H04N 21/4425; H04N 21/44008; H04L 67/02; H04L 65/608

(57) ABSTRACT

A method for processing video stream data, including: acquiring video source information of video streams having multiple resolutions; selecting, according to the video source information, a video stream having a highest resolution as a target video stream, and playing the target video stream; switching to a lower resolution video stream, if a network error or a decoding error occurs in the playing process; and playing the lower resolution video stream. Is addition, embodiments of the present invention further provide a corresponding apparatus and system for processing data of a video stream.

### RELATED APPLICATION

This application is a continuation application of PCT Application No. PCT/CN2016/077717, filed on Mar. 29,2016, which claims priority to Chinese Patent Application No, 2015101766281, filed on Apr. 15,2015, and entitled “METHOD, APPARATUS, AND SYSTEM FOR PROCESSING DATA OF VIDEO STREAM” all of which are incorporated by reference in entirety.

### FIELD OF THE TECHNOLOGY

The present invention relates to the field of communication technologies, and in particular, to a method, an apparatus, and a system for processing data of a video stream.

### BACKGROUND OF THE DISCLOSURE

With increasing demand of multi-media access anytime and anywhere, watching clear and smooth video sources in real time has become a preferred option of many users when watching video programs.

Common five video broadcast technologies mainly include HTTP Live Streaming (HLS) and a real time streaming media protocol based on the Real Time Streaming Protocol (RTSP)/Real-time Transport Protocol (RTP). Currently, most mainstream live video websites provide HLS live sources for mobile terminals, and therefore, this requires that video playing applications of the mobile terminals support the HLS protocol. Current video players generally directly select, when playing HLS video sources having multiple resolutions, a video stream having one of the resolutions according to a default setting or user setting.

In many applications, a video stream having a set the resolution is directly selected for broadcasting, while the selected resolution may not be suitable for a current broadcasting environment. Therefore, the broadcasting quality of a live video may be greatly affected. For example, the images may be very clear but stall frequently, or the video is played smoothly but the images are very blurry.

### SUMMARY

Embodiments of the present invention provide a method, apparatus, and system for processing data of a video stream, and can flexibly adjust resolution according to a current playing situation, thereby greatly improving playing quality of a live video.

An aspect of the present disclosure provides a method for processing video stream data, including: acquiring video source information, of video streams having multiple resolutions; selecting, according to the video source information, a video stream having a highest resolution as a target video stream, and playing the target video stream; switching to a lower resolution video stream, if a network error or a decoding error occurs in a playing process; and playing the lower resolution video stream.

Another aspect of the present disclosure provides a terminal for processing video stream data, including: a processor, a memory storing a plurality of program, units to be executed by the processor, the plurality of program units including: an information acquisition unit, configured to acquire video source information of video streams having multiple resolutions; a processing unit, configured to select, according to the video source information, a video stream having a highest resolution as a target video stream, and play the target video stream; and a switching unit, configured to switch to a lower resolution video stream for playing, if a network error or a decoding error occurs in the playing process.

Another-aspect of the present disclosure provides a system for processing data of a video stream, including any apparatus for processing data of a video stream provided in the embodiments of the present invention.

Another aspect of the present disclosure provides a computer storage medium, where the storage medium stores a computer processor executable instruction, and the processor executable instruction is used for performing the following operations: acquiring video source information of video streams having multiple resolutions; selecting, according to the video source information, a video stream having a highest resolution as a target video stream, and playing the target video stream; switching to a lower resolution video stream, if a network error or a decoding error occurs in a playing process; and playing the lower resolution video stream.

In the embodiments of the present invention, video source information of video streams having multiple resolutions is acquired; a video stream having a highest resolution is selected as a target video stream according to the video source information, and the target video stream is played; and if a network error or a decoding error occurs in the playing process, a played video is switched to a lower resolution video stream for playing. In this way, an objective of automatically adjusting a video resolution according to a current playing status, so that playing of a live video can reach an optimal state in a current playing environment, thereby greatly improving playing quality of the live video.

### BRIEF DESCRIPTION OF THE DRAWINGS

To describe the technical solutions in the embodiments of the present invention more clearly, the following briefly describes the accompanying drawings required for describing the embodiments. Apparently, the accompanying drawings in the following description show merely some embodiments of the present invention, and a person skilled in the art may still derive other drawings from these accompanying drawings without creative efforts.

FIG. 1 is a flowchart of a method for processing data of a video stream according to an embodiment of the present invention;

FIG. 2 is another flowchart of a method for processing data of a video stream according to an embodiment of the present invention;

FIG. 3 is a schematic structural diagram of an apparatus for processing data of a video stream according to an embodiment of the present invention; and

FIG. 4 is a schematic structural diagram of a mobile terminal according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person skilled in the art based on the embodiments of the present invention without creative efforts shall fall within the protection scope of the present invention.

Embodiments of the present invention provide a method, an apparatus, and a system for processing data of a video stream, which will be separately described below.

### Embodiment 1

In this embodiment, a description is made from the perspective of an apparatus for processing data of a video stream. The apparatus for processing data of a video stream specifically may be integrated in a mobile terminal, and the mobile terminal specifically may be a device such as a mobile phone or a tablet computer.

A method for processing data of a video stream includes: acquiring video source information of video streams having multiple resolutions; selecting, according to the video source information, a video stream having a highest resolution as a target video stream, and playing the target video stream; and switching a played video to a lower resolution video stream for playing if a network error or a decoding error occurs in the playing process.

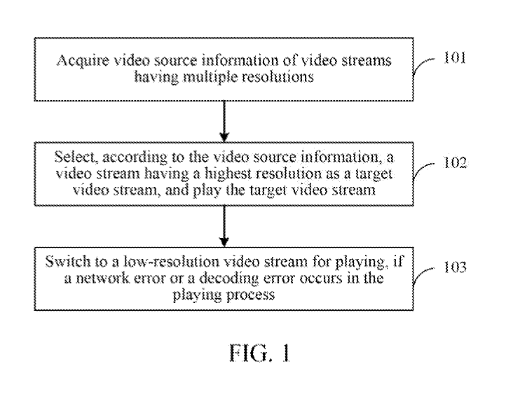

As shown in FIG. 1, a specific procedure of the method for processing data of a video stream may be as follows.

101: Acquire video source information of video streams having multiple resolutions.

The video streams having multiple resolutions may be provided by a multi-resolution video source, and the multi-resolution video source refers to that a video source can provide video streams having multiple types of definition, such as standard definition, high definition, ultra definition, and ultra high definition. In an HLS video stream media protocol, a multi-resolution video source refers to that multiple different m3u8 index files are nested in an m3u8 index file, and each index file corresponds to different video resolutions.

The video source information includes information such as resolution information, and link addresses of video streams corresponding to the resolutions. For example, if the resolutions are classified, in ascending order, into several levels such as smooth, standard definition, high, definition, and ultra high definition, m this case, the video source information may include resolution information such as “smooth,” “standard definition,” “high definition,” and “ultra high definition,” and may include a link address of a video stream corresponding to “smooth,” a link address of a video stream corresponding to “standard definition,” a link address of a video stream corresponding to “high definition,” a link address of a video stream corresponding to “ultra high definition,” and the like.

102: Select, according to the video source information, a video stream having a highest resolution as a target video stream, and play die target video stream. For example, the step specifically may be as follows.

(1) Create a video player, referred to as a player for short.

The player refers to software that can play a video stream stored in a digital signal form.

(2) Select, according to the video source information, a video stream having a highest resolution as a target video stream.

For example, if the resolution information includes “smooth,” “standard definition,” “high definition,” and “ultra high definition” where a resolution, of “ultra high definition” is the highest, in this case, a video corresponding to “ultra high definition” may be selected as a target video.

For another example, if the resolution information includes “smooth,” “standard definition,” and “high definition,” where a resolution of “high definition” is the highest, in this case, a video corresponding to “high definition” may be selected as a target video.

The rest can be deduced by analogy.

(3) Acquire corresponding video data according to a link address of the target-video stream.

For example, specifically, a corresponding m3u8 index file may be downloaded according to the link address of the target video, and then the corresponding video data may be acquired according to the m3u8 index file.

The video data may include a video stream, and may further include corresponding information of the video stream, such as environment information needed for playing the video stream (that is, playing environment information), for example, a needed bandwidth, a software release, and/or a hardware requirement on the mobile terminal.

(4) Create a decoder of the player according to the video data, to play the video.

For example, specifically, a decoder of the player may be created according to the playing environment information of the video data, and then the video stream is decoded by using the decoder, and the decoded video stream is played by using the player.

The decoder refers to a program, or a device that can decode a digital video stream, and includes a hardware decoder and a software decoder. The hardware decoder performs decoding by using a decoding chip of a mobile phone; the software decoder performs decoding by using a software program; and if a hardware decoder is used, creating a decoder refers to setting (initializing) the hardware decoder; or if a software decoder is used, creating a decoder refers to generating and setting the software decoder.

103: Switch a played video to a lower resolution video stream for playing, if a network error or a decoding error occurs in the playing process. For example, specifically, the step may be as follows.

(1) Release a player resource and the decoder.

The player resource includes resources such as a player engine and a parser.

(2) Select, according to the video source information, a video stream having a lower resolution as a target video stream, and returning to execute the step (that is, step (2) in step 102) of acquiring corresponding video data according to a link address of the target video stream.

For example, using that an originally selected resolution is “ultra high definition” as an example, in this case, a video stream having a lower resolution may be selected according to the video source information, that is, after a “high definition” video stream is used as a target video stream, corresponding video data is acquired according to a link address of the “high definition” video stream. Then a decoder of the player is created according to the video data, to play the video. Afterwards, if a network error or a decoding error occurs in the playing process, a video stream having a lower resolution is selected according to the video source information, for example, a “standard definition” video stream is used as a target video stream, and the like, until selected video stream, can be successfully played. That is, a player first attempts to play an “ultra high definition” video stream having highest definition, and if the mobile terminal cannot play the video stream, normally, the player continues to attempt, to play an “ultra definition” video stream, a “high definition” video stream, a “standard definition” video stream, and the like, until the mobile terminal can normally play a video.

Optionally, to ensure that a video having a lower resolution can be acquired, and avoid affecting effectiveness of an executed procedure, before releasing a player resource and the decoder, whether there is a video stream having a lower resolution may further be determined, and if yes, the step of releasing a player resource and the decoder is performed. That is, before the step of “releasing a player resource and the decoder,” the method may further include determining whether there is a video stream having a lower resolution, and if yes, performing the step of releasing a player resource and the decoder; or if not, sending an error prompt for example, displaying, on a screen of the mobile terminal, prompt information that there is an error in video live broadcast.

There may be multiple ways to determine whether there is a video stream having a lower-resolution, for example, determining, according to the video source information, whether there is a video stream having a lower resolution; or, if an m3u8 index file has been downloaded, determining whether there is a nested video stream having a lower resolution in the m3u8 index file.

It can be known from, the above that, in this embodiment, video source information of video streams having multiple resolutions is acquired; a video stream having a highest resolution is selected as a target video stream according to the video source information, and the target video stream is played; and if a network error or a decoding error occurs in the playing process, a played video is switched to a lower resolution video stream for playing, so as to achieve an objective of automatically adjusting video resolution according to a current playing status, so that playing of a live video can reach an optimal state in a current playing environment, thereby greatly improving playing quality of the live video.

### Embodiment 2

According to the method described in Embodiment 1, the following further makes a detailed description by using examples.

In this embodiment, a description is made by using an example in which the apparatus for processing data of a video stream is specifically integrated in a mobile terminal.

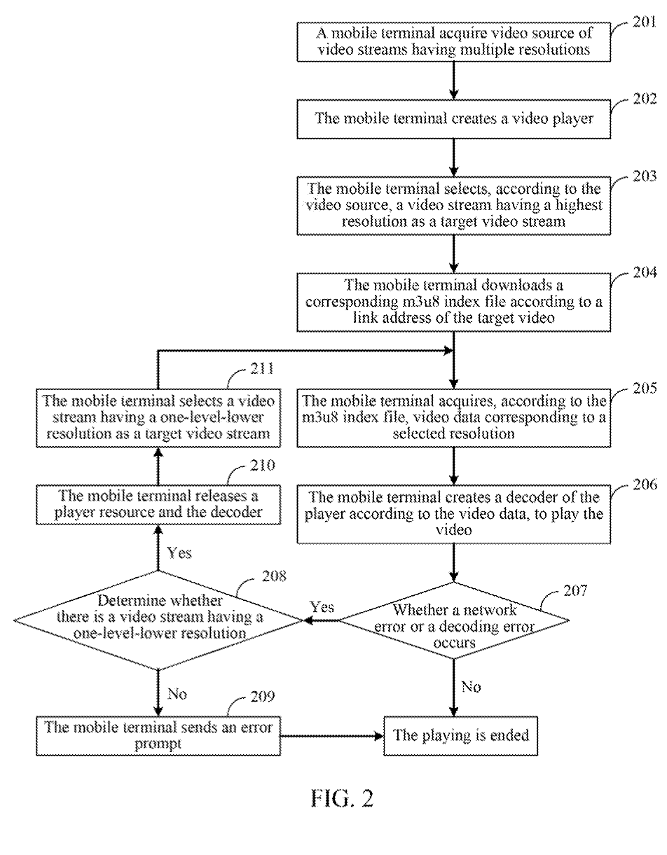

As shown in FIG. 2, a specific procedure of a method, for processing data of a video stream may be as follows:

201: A mobile terminal acquires video source information of video streams having multiple resolutions.

The video source information includes information such as resolution information, and link addresses of video streams corresponding to the resolutions. For example, if the resolutions are classified, in ascending order, into several levels such as smooth, standard definition, high definition, and ultra high definition, in this case, the video source information may include resolution information such, as “smooth,” “standard definition,” “high definition” and “ultra high definition,” and may include a link address of a video stream corresponding to “smooth,” a link address of a video stream corresponding to “standard definition,” a link address of a video stream corresponding to “high definition,” a link address of a video stream, corresponding to “ultra high definition,” and the like.

202: The mobile terminal creates a video player. The video player may be any software application that can play the data of the video stream.

For example, specifically, functional modules in the player may be created, and a user interface (UI) of a player may be created. A UI of a player refers to a user visible interface in a video player, including multiple parts: an area displaying a video image, a user operable control bar area, and an area for displaying a playing error prompt.

203: The mobile terminal selects, according to the video source information, a video stream having a highest resolution as a target video stream.

For example, if the resolution information includes “smooth,” “standard definition,” “high definition” and “ultra high definition,” where a resolution of “ultra high definition” is the highest, in this case, a video corresponding to “ultra high definition” may be selected as a target video.

For another example, if the resolution information includes “smooth,” “standard definition,” and “high definition,” where a resolution of “high definition” is the highest in this case, a video corresponding to “high definition” may be selected as a target video.

The rest can be deduced by analogy.

204: The mobile terminal downloads a corresponding m3u8 index file according to a link address of the target video.

205: The mobile terminal acquires, according to the m3u8 index file, video data corresponding to a selected resolution.

The video data may include a video stream, and corresponding information of the video stream, such as environment information needed for playing the video stream (that is, playing environment information), for example, a needed bandwidth, a software release, and/or a hardware requirement on the mobile terminal.

206: The mobile terminal creates a decoder of the player according to the video data, to play the video. The decoder may be any software application that can be coupled to the player and decode the video stream data.

For example, specifically, a decoder of the player may be created according to the playing environment information of the video data, and then the video stream is decoded by using the decoder, and the decoded video stream is played by using the player.

During the playing process, on the premise that audio-video synchronization is considered, the player may decode the audio and the video separately, and then output a decoded video image to a screen of a mobile phone, and output decoded audio data to a loudspeaker of the mobile phone; details are not described herein again.

207: The mobile terminal determines whether a network error or a decoding error occurs in the playing process, and if yes, performs step 208; or if not, continues to play until the playing is ended.

208: The mobile terminal determines whether there is a video stream having a lower resolution, and if yes, performs step 210; or if not, continues to perform step 209.

For example, the mobile terminal specifically may determine whether there is a nested video stream having a lower resolution in a downloaded m3u8 index file, and if yes, performs step 210; or if not, performs step 209.

209: The mobile terminal sends an error prompt, for example, displaying, on a screen of the mobile terminal, prompt information that there is an error in video live broadcast, and the playing is ended.

210: The mobile terminal releases a player resource, such as a player engine and a parser, and releases the decoder.

211: The mobile terminal selects, according to the video source information, a video stream having a lower resolution as a target video stream, and returns to perform the step of acquiring, according to the m3u8 index file, video data corresponding to a selected resolution, that is, returning to perform step 205.

For example, if an originally selected video stream is a video stream having a resolution of “ultra high definition,” in this case, a video stream having a lower resolution, such as a video stream having a resolution of “high definition,” may be selected as a target video stream.

For another example, if an originally selected video stream is a video stream having a resolution of “high definition,” in this case, a video stream having a lower resolution, such as a video stream having a resolution of “standard definition,” may be selected as a target video stream.

The rest can be deduced by analogy.

It can be known from the above that, in this embodiment, video source information of video streams having multiple resolutions is acquired; a video stream having the highest resolution is selected as a target video stream according to the video source information, and the target video stream is played; and if a network error or a decoding error occurs in the playing process, the played video is switched to a video stream having a lower resolution for playing. That is, in this solution, a player may first attempt to play a video stream having a highest definition, and if the mobile terminal cannot play the video stream normally, the player then continues to attempt to play, in descending order, video streams having lower resolutions, until the mobile terminal can normally play a live video, so as to achieve an objective of automatically adjusting video resolution according to a current playing status, so that playing of a live video can reach an optimal state in a current playing environment, thereby greatly improving playing quality of the live video.

### Embodiment 3

To better implement the foregoing method, this embodiment of the present invention further provides a terminal (i.e., an apparatus) for processing video stream data. As shown in FIG. 3, the terminal for processing video stream data may include a processor, a memory storing a plurality of program units to be executed by the processor, the plurality of program units including an information acquisition unit 301, a processing unit 302, and a switching unit 303.

The information, acquisition, unit 301 is configured to acquire video source information of video streams having multiple resolutions.

The video source information includes information such as resolution information, and link addresses of video streams corresponding to the resolutions. For example, if the resolutions are classified, in ascending order, into several levels such as smooth, standard definition, high definition, and ultra high definition, in this case, the video source information may include resolution, information such as “smooth,” “standard definition,” “high definition,” and “ultra high definition” and may include a link address of a video stream corresponding to “smooth,” a link address of a video stream corresponding to “standard definition,” a link address of a video stream corresponding to “high definition,” a link address of a video stream corresponding to “ultra high definition,” and the like.

The processing unit 302 is configured to select, according to the video source information, a video stream, having a highest resolution as a target video stream, and play the target video stream.

The switching unit 303 is configured to: switch a played video to a lower resolution video stream for playing, if a network error or a decoding error occurs in the playing process.

For example, the processing unit 302 may include a creation subunit, an acquisition subunit, and a playing subunit.

The creation subunit is configured to create a player, and select, according to the video source information, a video stream having a highest resolution as a target video stream.

For example, if the resolution information includes “smooth” “standard definition,” “high definition” and “ultra high definition,” where a resolution of “ultra high definition” is the highest, in this case, a video corresponding to “ultra high definition” may be selected as a target video.

For another example, if the resolution information includes “smooth,” “standard definition,” and “high definition,” where a resolution of “high definition” is the highest, in this case, a video corresponding to “high definition” may be selected as a target. video.

The rest can be deduced by analogy.

The data acquisition subunit is configured to acquire corresponding video data according to a link address of the target video stream.

For example, the data acquisition subunit specifically may be configured to download a corresponding m3u8 index file according to the link address of the target video stream, and acquire corresponding video data according to the m3u8 index file.

The video data may include a video stream, and may further include corresponding information of the video stream, such as environment information needed for playing the video stream (that is, playing environment information), for example, a needed bandwidth, a software release, and/or a hardware requirement on a mobile terminal.

The playing submit is configured to create a decoder of the player according to the video data, to play the video.

For example, the playing subunit specifically may be configured to create a decoder of the player according to the playing environment information of the video data, and then decode the video stream by using the decoder, and play the decoded video stream by using the player.

The switching unit is specifically configured to release a player resource and the decoder, select a video stream having a lower resolution, and trigger the data acquisition subunit to execute the operation of acquiring corresponding video data according to a link address of the target video stream.

For example, if an originally selected video stream is a video stream having a resolution of “ultra high definition,” in this case, a video stream having a resolution of “high definition” may be selected as a target video stream.

Optionally, to ensure that a video having a lower resolution can be acquired, and avoid affecting effectiveness of a performed procedure, before releasing a player resource and the decoder, whether there is a video stream having a lower resolution may further be determined, and if yes, the step of releasing a player resource and the decoder is performed.

The switching unit 303 may further be configured to determine whether there is a video stream having a lower resolution, and if yes, perform the step of releasing a player resource-and the decoder; or if not, send an error prompt, for example, displaying, on a screen of the mobile terminal, prompt information that there is an error in video live broadcast.

There may be multiple ways to determine whether there is a video stream having a lower resolution, for example, determining, according to the video source information, whether there is a video stream having a lower resolution; or, if an m3u8 index file has been downloaded, determining whether there is a nested, video stream having a lower resolution in the m3u8 index file.

During specific implementation, the foregoing units may be implemented as independent entities, or may be implemented as one or more entities through random combination. For specific implementation of the foregoing units, refer to the above method embodiments, and details are not described herein again.

The apparatus for processing data of a video stream may be specifically integrated in a mobile terminal, and the mobile terminal specifically may be a device such as a mobile phone or a tablet computer.

It can be known from the above that, in the apparatus for processing data of a video stream of this embodiment, the information acquisition unit 301 may acquire video source information of video streams having multiple resolutions; the playing unit 302 selects, according to the video source information, a video stream having a highest resolution as a target video stream, and plays the target video stream; and if a network error or a decoding error occurs in the playing process, the switching unit 303 switches a played video to a lower resolution video stream for playing, so as to achieve an objective of automatically adjusting video resolution according to a current playing status, so that playing of a live video can reach an optimal state in a current playing environment, thereby greatly improving playing quality of the live video.

### Embodiment 4

Correspondingly, this embodiment of the present invention further provides a system for processing data of a video stream, including any apparatus for processing data of a video stream provided by the embodiments of the present invention. Refer to Embodiment 3 for details. The apparatus for processing data of a video stream may be specifically integrated in a mobile terminal, and the mobile terminal specifically may be a device such as a mobile phone or a tablet computer.

Using an example in which the apparatus for processing data of a video stream maybe specifically integrated in a mobile terminal, details specifically may be as follows.

The mobile terminal is configured to acquire video source information of video streams having multiple resolutions; select a video stream having the highest resolution as a target video stream according to the video source information, and play the target video stream; and if a network error or a decoding error occurs in the playing process, switch a played video to a lower resolution video stream for playing.

The video source information includes information such as resolution information, and link addresses of video streams corresponding to the resolutions.

For example, the mobile terminal specifically may be configured to acquire video source information of video streams having multiple resolutions; create a player; select a video stream having the highest resolution according to the video source information; acquire corresponding video data according to a link address of the target video stream; and then create a decoder of the player according to the video data to play the video; and if a network error or a decoding error occurs in a playing process, release a player resource and the decoder; select, according to the video source information, a video stream, having a lower resolution as a target video stream; and return to perform the operation of acquiring corresponding video data according to the link address of the target video stream.

Optionally, to ensure that a video having a lower resolution can be acquired, and avoid affecting effectiveness of a performed procedure, before releasing a player resource and the decoder, whether there is a video stream having a lower resolution may further be determined, and if yes, the operation of releasing a player resource and the decoder is performed.

There may be multiple ways to determine whether there is a video stream having a lower resolution, for example, determining, according to the video source information, whether there is a video stream having a lower resolution; or, if an m3u8 index file has been downloaded, determining whether there is a nested, video stream having a lower resolution in the m3u8 index file.

In addition, the system for processing data of a video stream may further include other devices, such as a server as follows.

The server is configured to provide video streams having multiple resolutions for the mobile terminal.

Refer to the above embodiments for specific implementation of the foregoing operations, and details are not described herein again.

The system for processing data of a video stream may include any apparatus for processing data of a video stream provided in the embodiments of the present invention, and therefore may achieve beneficial effects that can be implemented by using any apparatus for processing data of a video stream provided in the embodiments of the present invention. Refer to the foregoing embodiments for specific content, and details are not described, herein again.

### Embodiment 5

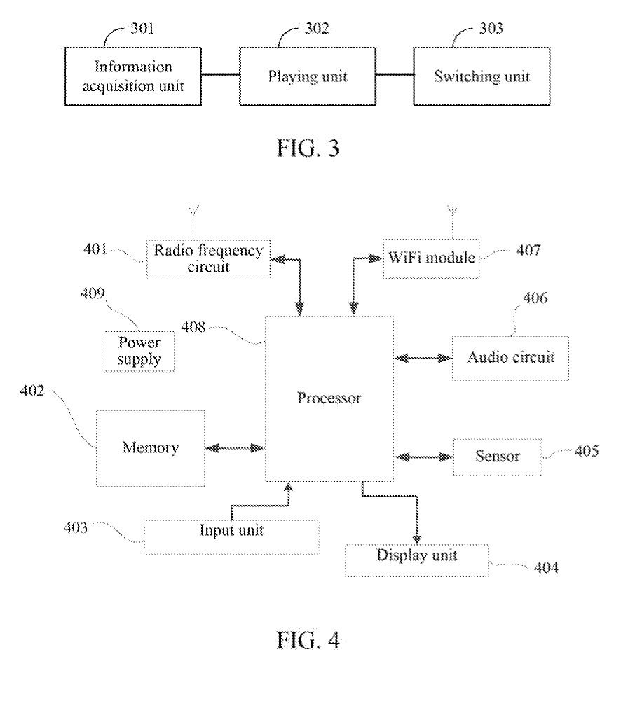

Correspondingly, this embodiment of the present invention further provides a mobile terminal. As shown in FIG. 4, the mobile terminal may include components such as a radio frequency (RF) circuit 401, a memory 402 including one or more computer readable storage media, an input unit 403, a display unit 404, a sensor 405, an audio circuit 406, a wireless fidelity (WiFi) module 407, a processor 408 including one or more processing cores, and a power supply 409. A person skilled in the art may understand that the mobile terminal structure shown in FIG. 4 does not limit the mobile terminal, and may include components more or fewer than those in the drawings, or a combination of some components, or a different component deployment.

The RF circuit 401 may be configured to receive and send signals during an information receiving and sending process or a call process. Particularly, the RF circuit 401 receives downlink, information from a base station, then delivers the downlink information to the one or more processors 680 for processing, and sends related uplink data to the base station. Generally, the RF circuit 401 includes, but is not limited to, an antenna, at least one amplifier, a tuner, one or more oscillators, a subscriber identity module (SIM) card, a transceiver, a coupler, a low noise amplifier (LNA), a duplexer, and the like. In addition, the RF circuit 401 may also communicate with a network and another device by wireless communication. The wireless communication may use any communications standard or protocol, which includes, but is not limited to, Global System for Mobile communications (GSM), General Packet Radio Service (GPRS), Code Division Multiple Access (CDMA), Wideband Code Division Multiple Access (WCDMA), Long Term Evolution (LTE), e-mail, Short Messaging Service (SMS), and the like.

The memory 402 may be configured to store a software program and a module, and the processor 408 runs the software program and the module that are stored in the memory 402, to perform various functional applications and data processing. The memory 402 may mainly include a program storage area and a data storage area. The program storage are a may store an operating system, an application programs (such as a video player application, a decoder application) needed by at least one function (such as m audio playback function and an image display function). The data storage area may store data (such as audio data and an address book) created according to use of the mobile terminal. In addition, the memory 402 may include a high-speed random access memory, and may further include a non-volatile memory such as at least one magnetic disk storage device, a flash memory, or another volatile solid-state storage device. Correspondingly, the memory 402 may further include a memory controller, so as to provide access of the processor 408 and the input, unit 403 to the memory 402.

The input unit 403 may be configured, to receive input digit or character information, and generate a keyboard, mouse, joystick, optical, or track ball signal input related to the user setting and function control. Specifically, in a specific embodiment, the input unit 403 may include a touch-sensitive surface and another input device. The touch-sensitive surface, which may also be referred to as a touch screen or a touch panel, may collect a touch operation of a user on or near the touch-sensitive surface (such as an operation of a user on or near the touch-sensitive surface by using any suitable object or accessory, such as a linger or a stylus), and drive a corresponding connection apparatus according to a preset program. Optionally, the touch-sensitive surface may include two parts; a touch detection apparatus and a touch controller. The touch detection apparatus detects a touch position of the user, detects a signal generated by the touch operation, and transfers the signal, to the touch controller. The touch controller receives the touch information from the touch detection apparatus, converts the touch information into touch point coordinates, and sends the touch point coordinates to the processor 408. Moreover, the touch controller can receive and execute a command sent from the processor 408. In addition, the touch-sensitive surface maybe may be a resistive, capacitive, infrared, or surface sound wave type touch-sensitive surface. In addition to the touch-sensitive surface, the input unit 403 may further include the another input device. Specifically, the another input device 132 may include, but is not limited to, one or more of a physical keyboard, a functional key (such as a volume control key or a switch key), a track ball, a mouse, and a joystick.

The display unit 404 may be configured to display information input by the user or information provided for the user, and various graphical user interfaces of the mobile terminal. The graphical user interfaces may be formed by a graph, a text, an icon, a video, or any combination thereof. The display unit 404 may include a display panel. Optionally, the display panel may be configured by using a liquid crystal display (LCD), an organic light-emitting diode (OLED), or the like. Further, the touch-sensitive surface may cover the display panel. After detecting a touch operation on or near the touch-sensitive surface, the touch-sensitive surface transfers the touch operation to the processor 408, so as to determine the type of the touch event. Then, the processor 408 provides a corresponding visual output on the display panel according to the type of the touch event. Although, in FIG. 4, the touch-sensitive surface and the display panel are used as two separate parts to implement input and output functions, in some embodiments, the touch-sensitive surface and the display panel may be integrated to implement the input and output functions.

The mobile terminal may further include at least one sensor 405, such as an optical sensor, a motion sensor, and other sensors. Specifically, the optical sensor may include an ambient light sensor and a proximity sensor. The ambient light sensor can adjust luminance of the display panel according to brightness of the ambient light. The proximity sensor may switch off the display panel and/or backlight when the mobile terminal is moved to the ear. As one type of motion sensor, a gravity acceleration sensor can detect magnitude of accelerations in various directions (generally on three axes), may detect magnitude and a direction of the gravity when static, and may be applied to an application that recognizes the attitude of the mobile phone (for example, switching between landscape orientation and portrait orientation, a related game, and magnetometer attitude calibration), a function related to vibration recognition (such as a pedometer and a knock), and the like. Other sensors, such as a gyroscope, a barometer, a hygrometer, a thermometer, and an infrared sensor, which may be configured in the mobile terminal, are not further described herein,

The audio circuit 406, a loudspeaker, and a microphone may provide audio interfaces between the user and the mobile terminal. The audio circuit 406 may convert received audio data into an electric signal, and transmit the electric signal to the loudspeaker. The loudspeaker converts the electric signal into a sound signal for output. On the other hand, the microphone converts a collected sound signal into an electric signal. The audio circuit 406 receives the electric signal and converts the electric signal into audio data, and outputs the audio data to the processor 408 for processing. Then, the processor 408 sends the audio data to, for example, another mobile terminal by using the RF circuit 401, or outputs the audio data to the memory 402 for further processing. The audio circuit 406 may further include an earplug jack, so as to provide communication between a peripheral earphone and the mobile terminal.

WiFi is a short distance wireless transmission technology. The mobile terminal may help, by using the WiFi module 407, the user to receive and send e-mails, browse a webpage, access streaming media, and so on, which provides wireless broadband Internet access for the user. Although FIG. 4 shows the WiFi module 407, it may be understood that the WiFi module 407 is not a necessary component of the mobile terminal, and when required, the WiFi module 407 may be omitted as long as the scope of the essence of the present disclosure is not changed.

The processor 408 is the control center of the mobile terminal, and is connected to various parts of the mobile phone by using various interfaces and lines. By running or executing the software program and/or module stored in the memory 402, and invoking data stored in the memory 402, the processor 408 performs various functions and data processing of the mobile terminal, thereby performing overall monitoring on the mobile phone. Optionally, the processor 408 may include one or more processing cores. Preferably, the processor 408 may integrate an application processor and a modem. The application processor mainly processes an operating system, a user interface, an application program, and the like. The modem mainly processes wireless communication. It can be understood that the foregoing modem may not be integrated into the processor 408.

The mobile terminal further includes the power supply 409 (such as a battery) for supplying power to the components. Preferably, the power supply may be logically connected to the processor 408 by using a power supply management system, thereby implementing functions such as charging, discharging and power consumption management by using the power management system. The power supply 409 may further include one or more direct current or alternating current power supplies, a re-charging system, a power failure detection circuit, a power supply converter or inverter, a power supply state indicator, and any other components.

Although not shown in the figure, the mobile terminal may further include a camera, a Bluetooth module, and the like, which are not further described herein. Specifically, in this embodiment, the processor 408 in the mobile terminal may load, according to the following instruction, executable files corresponding to processes of one or more application programs, into the memory 402, and the processor 408 runs an application program stored in the memory 402, so as to implement various video broadcasting functions, as described above. Such functions include acquiring video source information of video streams having multiple resolutions; selecting, according to the video source information, a video stream having a highest resolution as a target video stream, and playing the target video stream; and switching a played video to a lower resolution video stream for playing, if a network error or a decoding error occurs in a playing process.

The video source information includes information such as resolution information, and link addresses of video streams corresponding to the resolutions.

The step of “selecting, according to the video source information, a video stream having a highest resolution as a target video stream, and playing the target video stream” specifically may include creating a player; selecting, according to the video source information, a video stream having the highest resolution as a target video stream; acquiring corresponding video data according to a link address of the target video stream; and then creating a decoder of the player according to the video data, to play the video.

The step of “switching a played video to a video stream having a low resolution for playing” specifically may include releasing a player resource and the decoder, and selecting, according to the video source information, a video stream having a lower resolution as a target video stream, and returning to perform the operation of acquiring corresponding video data according to the link address of the target video stream.

Optionally, to ensure that a video having a lower resolution can be acquired, and avoid that effectiveness of a performed procedure is affected, before releasing a player resource and the decoder, whether there is a video stream having a lower resolution may further be determined, and if yes, the operation of releasing a player resource and the decoder is performed.

There may be multiple ways to determine whether there is a video stream having a lower resolution, for example, determining, according to video source information, whether there is a video stream having a lower resolution; or, if an m3u8 index file is downloaded, determining whether there is a nested video stream lower for one level in the m3u8 index file.

Refer to the foregoing embodiments for the foregoing specific operations, and details are not described herein again.

It can be known from the above mentioned, that, the mobile terminal of this embodiment can acquire video source information of video streams having multiple resolutions; select, according to the video source information, a video stream having the highest resolution as a target video stream, and play the target video stream; and if a network error or a decoding error occurs in a playing process, switch a played video to a lower resolution video stream for playing, so as to achieve an objective of automatically adjusting video resolution according to a current playing situation, so that playing of a live video can reach the best status in current playing environment, thereby greatly improving playing quality of the live video.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory (ROM, Read Only Memory), a random access memory (RAM, Random Access Memory), a magnetic disk, an optical disc, or the like.

The method, apparatus, and system for processing data of a video stream provided in the embodiments of the present invention are described in detail above. The principle and implementation of the present invention are described herein through specific examples. The description about the embodiments of the present invention is merely provided to help understand the method and core ideas of the present invention. In addition, persons of ordinary skill in the art can make variations and modifications to the present invention in terms of the specific implementations and application scopes according to the ideas of the present invention. Therefore, the content of specification shall not be construed as a limit to the present invention.

What is claimed is:

1. A method for processing video stream data, comprising:
acquiring, by a terminal, video source information of video streams having multiple resolutions;
selecting, by the terminal according to the video source information, a video stream having a highest resolution as a target video stream, and playing the target video stream;
switching, by the terminal, to a lower resolution video stream, if a network error or a decoding error occurs in a playing process; and
playing, by the terminal, the lower resolution video stream.

2. The method according to claim 1, wherein if the video source information comprises resolution information and link addresses of video streams corresponding to the resolutions, the selecting, according to the video source information, a video stream having a highest resolution as a target video stream, and playing the target video stream comprises:
creating a player, and selecting, according to the video source information, the video stream having the highest resolution as the target video stream;
acquiring corresponding video data according to a link address of the target video stream;
creating a decoder of the player according to the corresponding video data.

3. The method according to claim 2, wherein the switching to a lower resolution video stream for playing comprises:
releasing a player resource and the decoder;
selecting, according to the video source information, the video stream having the lower resolution as the target video stream, and returning to the step of acquiring the corresponding video data according to the link address of the target video stream.

4. The method according to claim 3, the releasing a player resource and the decoder, further comprising:
determining whether there is a video stream having a lower resolution; and
releasing the player resource and the decoder if there is the video stream having the lower resolution; or
sending an error prompt if there is no video stream having the lower resolution.

5. The method according to claim 1, wherein the acquiring corresponding video data according to a link address of the target video stream comprises;
downloading a corresponding m3u8 index file according to the link address of the target video; and
acquiring the corresponding video data according to the m3u8 index file.

6. A terminal for processing a video stream data, comprising: a processor, a memory storing a plurality of program units to be executed by the processor, the plurality of program units comprising:
an information acquisition unit, configured to acquire video source information of video streams having multiple resolutions;
a processing unit, configured to select, according to the video source information, a video stream having a highest resolution as a target video stream, and play the target video stream; and
a switching unit, configured to switch to a lower resolution video stream, if a network error or a decoding error occurs in the playing process.

7. The terminal according to claim 6, wherein the video source information comprises resolution information, and link addresses of video streams corresponding to the resolutions, and the processing unit comprises a creation subunit an acquisition subunit, and a playing subunit;
the creation subunit is configured to create a player, and select, according to the video source information, the video stream, having the highest resolution as the target video stream;
the data acquisition subunit is configured to acquire corresponding video data according to a link address of the target video stream; and
the playing subunit is configured to create a decoder of the player according to the corresponding video data.

8. The terminal according to claim 7, wherein
the switching unit is specifically configured to release a player resource and the decoder, select the video stream having the lower resolution, and trigger the data acquisition subunit to execute the operation of acquiring the corresponding video data according to the link address of the target video stream.

9. The terminal according to claim 8, wherein
the switching unit is further configured to determine whether there is a video stream having a lower resolution, and execute the operation of releasing a player resource and the decoder if there is the video stream having the lower resolution; or send an error prompt if there is no video stream having the lower resolution.

10. The terminal according to claim 6, wherein
the data acquisition subunit is specifically configured to download a corresponding m3u8 index file according to the link address of the target video stream, and acquire corresponding video data according to the m3u8 index file.

11. A system for processing data of a video stream, comprising the apparatus for processing data of a video stream according to claim 6.

12. A computer storage medium, wherein the storage medium stores computer processor executable instructions, and the processor executable instructions perform following operations:
acquiring video source information of video streams having multiple resolutions;
selecting, according to the video source information, a video stream having a highest resolution as a target video stream, and playing the target video stream; and
switching to a lower resolution video stream for playing, if a network error or a decoding error occurs in the playing process.

13. The computer storage medium according to claim 12, wherein if the video source information comprises resolution information and link addresses of video streams corresponding to the resolutions, the selecting, according to the video source information, a video stream having a highest resolution as a target video stream, and playing the target video stream comprises:
creating a player, and selecting, according to the video source information, the video stream having the highest resolution as the target video stream;
acquiring corresponding video data according to a link address of the target video stream;
creating a decoder of the player according to the corresponding video data.

14. The computer storage medium according to claim 13, wherein the switching to a lower resolution video stream for playing comprises:
releasing a player resource and the decoder;
selecting, according to the video source information, the video stream having the lower resolution as the target video stream, and returning to the step of acquiring the corresponding video data according to the link address of the target video stream.

15. The computer storage medium according to claim 14, the releasing a player resource and the decoder, further comprising:
determining whether there is a video stream having a lower resolution; and
releasing the player resource and the decoder if there is the video stream having the lower resolution; or
sending an error prompt if there is no video stream having the lower resolution,

16. The computer storage medium according to claim 15, wherein the acquiring corresponding video data according to a link address of the target video stream comprises:
downloading a corresponding m3u8 index file according to the link address of the target-video; and
acquiring the corresponding video data according to the m3u8 index file.
